(19) United States
(12) Patent Application Publication
(10) Pub. No.: US 2003/0007496 A1
(43) Pub. Date: Jan. 9, 2003

(54) System, apparatus and method for dynamically mapping virtual signaling system 7 circuit identification codes for use between voip gateways on IP-based networks

(76) Inventors: Gary D. Brown, Orem, UT (US); Scott Raffensparger, Orem, UT (US)

Correspondence Address: TRASK BRITT, P.O. BOX 2550, SALT LAKE CITY, UT, 84110, US

(21) Appl. No.: 10/147,289

(22) Filed: May 16, 2002

Related U.S. Application Data
(60) Provisional application No. 60/291,290, filed on May 16, 2001.

(51) Int. Cl. H04L 12/28; H04J 3/16

(52) U.S. Cl. 370/401; 370/352; 370/465

(57) ABSTRACT

The present invention is a system, apparatus and method for dynamically mapping virtual signaling system 7 (SS7) circuit identification codes (CICs) for use between Voice over Internet Protocol (VoIP) gateway switches to allow true SS7 signaling over IP-based packet networks.

### CROSS-REFERENCE TO RELATED APPLICATIONS

This utility patent application claims benefit of provisional patent application serial No. 60/291,290, filed May 16, 2001, the disclosure of which is incorporated herein by reference for all purposes.

### TECHNICAL FIELD

This invention relates generally to voice communications. More particularly, the invention relates to a system, apparatus and method for dynamically mapping virtual signaling system 7 (SS7) circuit identification codes (CICs) for use between and among voice over Internet protocol (VoIP) gateways on Internet Protocol (IP) based packet networks, such as the Internet.

### BACKGROUND OF THE INVENTION

Telephone calls over the Public Switched Telephone Network (PSTN) are accomplished using signals for ringing, busy, etc., using either in-band signaling or out-of-band signaling. Where in-band signaling is used, all of the signaling information is carried on the circuit or channel along with the telephone voice information. In the case of out-of-band signaling, the signaling information is carried on a different circuit than the telephone voice information. The most popular out-of-band signaling system that is used on the PSTN, is Signaling System 7 (SS7). SS7 signaling is used to manage ringing, busy, etc., signaling and also the setup and teardown of telephone calls. SS7 signaling is also used in communicating with multiple telephone switches for coordination of telephone call routing, acquiring and distributing billing information and many other processes associated with managing telephone calls on the PSTN. Physically, SS7 signaling is in the form of data packets, which have various specific SS7 protocol messages with predetermined formats for specific tasks in the management of telephone calls. SS7 messages are typically transmitted over redundant data links, often over dual point-to-point telephone lines using modems (A-link) or through a DS0 channel on two T1 or E1 digital spans (F-link). The redundant SS7 data links are associated with a finite number of bearer channels that carry the voice/audio, video or data information of telephone calls. On the PSTN, each bearer channel has a circuit identification code (CIC) unique to the set of data and bearer channels being used for the SS7 signaling and telephone calls, respectively.

SS7 is an international data network including signaling protocols that control the PSTN voice circuits and calls. SS7 has country-by-country variations. The International Telecommunications Union (ITU) SS7 is the base protocol upon which the national variants are based. The American National Standards Institute (ANSI) SS7 is the North American variant of SS7. The SS7 carries packet-based digital information which assists in fast call setup and routing. The SS7 also provides transaction capabilities using remote database interaction. The SS7 network is a data network that transmits messages between switches and other computers used in the PSTN. More than one message-based protocol can use the SS7 data network for transport of messages between switches and computers. Examples of message-based protocols that use the SS7 data network are Integrated Services Digital Network (ISDN) User Part (ISUP) and Transactions Capability (TCAP).

A simplified example of a telephone call using SS7 over the PSTN begins with an originating party taking the telephone off-hook and dialing the destination telephone number. The originating and terminating telephone switches communicate with each other by sending SS7 messages over the SS7 data network. The initial SS7 setup message is called an “initial address message” (IAM). The IAM is sent from the originating telephone switch to the terminating switch via any intermediary switches and sends the CIC number of the circuit that the telephone call will be sent on, as well as identifying information, such as the originating point code (OPC) and the destination point code (DPC) number that uniquely identify the originating and terminating switches. ANSI point codes are unique and formed of three fields of numbers separated by dashes, each field ranging from 0 to 255.

Once the IAM is sent, the terminating switch looks for the call on the bearer channel or circuit with the specified CIC number, and if successful, connects the destination party and returns an “address complete message” (ACM) back to the originating switch. The telephone call voice/audio, video or data information is then transmitted back and forth on the specified bearer channel. When the telephone call is completed, either the originating or terminating party hangs up the call. SS7 messages are then exchanged between the two switches for communicating the necessary information to tear down the call. Additionally, the SS7 messages exchanged during call teardown make the switching circuits available for other calls as well as acquire and distribute billing information about the completed call.

Recently, there has been considerable interest in utilizing IP-based packet networks, such as the Internet, for transmitting voice packets, also known as Voice over Internet Protocol (VoIP). In VoIP telephone calling, telephone call information is sent in messages using data packets over various paths in the IP-based packet network. Thus, VoIP telephone calls are not confined to specific circuits (digital channels or analog wires), i.e., they are “circuit-less”.

There are a number of protocols for sending packets over a packet-based network. Internet protocol (IP) is the base protocol upon which the Internet packet-based network operates. The IP protocol, by itself, is not a “reliable” protocol, meaning it does not guarantee delivery and receipt of a packet. Various other protocols operate on top of the IP protocol. For example, transmission control protocol (TCP) operates on top of IP (sometimes referred to as TCP/IP) and is commonly used to guarantee delivery of a data packet from the sender to the receiver. TCP/IP is a “reliable” protocol that guarantees delivery and order of packets, but which has a lot of overhead associated with it and can take a long time guaranteeing packet transmission. TCP/IP is the protocol used on the public Internet with Web browser software. However, it is highly unsuitable for the transport of realtime data such as voice and video.

The user datagram protocol (UDP) is another IP-based protocol that delivers data in the same manner in which it was sent, e.g., if the sender transmits 20 bytes in a packet, they are delivered to the receiver as 20 bytes together. UDP is an “unreliable” protocol, i.e., a protocol that does not guarantee delivery or order of packets. However, UDP protocol has little overhead. The realtime transport protocol (RTP) is a protocol that is used to transport realtime data, such as voice or video. RTP is an “unreliable” protocol built on top of the UDP protocol that does not guarantee delivery of packets, but which has little overhead. The realtime transport control protocol (RTCP) is used to report on the performance of a particular RTP transport session. RTCP delivers information such as the number of packets transmitted and received, the round-trip delay, jitter delay, etc. that are used to measure quality of service in an IP-based packet network.

Recently, the stream control transmission protocol (SCTP) was developed for transmitting SS7 messages over an IP-based packet network. Since an IP-based packet network typically does not guarantee delivery of messages through the network, nor provide for redundant physical paths through the network, the SCTP protocol performs these functions. Until SCTP was developed, it was difficult if not impossible to transmit the kind of information that is contained in conventional SS7 protocol messages over an IP-based packet network. TCP, UDP, RTP and SCTP all operate on top of IP and use it as their transport protocol.

Many of the current VoIP signaling protocols originated in the data network world. Most were created for a specific purpose and then were adapted or forced to evolve to handle voice calls over a VoIP network. Because of this heritage, the VoIP protocols usually follow a call signaling model patterned after something other than a voice call, and they do not cleanly handle voice calls nor do they seamlessly inter-operate with the PSTN network. Examples of these protocols are H.323, Media Gateway Control Protocol (MGCP), and Session Initiation Protocol (SIP).

The H.323 protocol started out as a method for transporting data, voice, and video over a local area network. It follows the “semi-intelligent gateway/semi-intelligent gatekeeper” network model. The protocol adopted portions of the ISDN Q.931 call signaling protocol for handling the voice call setup and teardown, but did not use all of the important parts of the ISDN protocol, such as answer indication. This deficiency crippled the protocol for use as a voice gateway protocol because all voice carrier networks require some indication of answer, i.e., answer supervision, so they know when to start metering the voice call for billing purposes. Other artifacts of the H.323 protocol were introduced to permit remote intelligence, i.e., to allow for a gatekeeper, but this simply added complexity to the protocol and slowed down the actual call setup and teardown. For example, H.323 may require 20 or more messages per call during setup and teardown. The H.323 protocol has gone through several revisions, with each attempting to remedy problems of this legacy VoIP protocol.

The MGCP protocol also came out of the data networking world where its ancestor protocols were used to control devices over an IP network. It was adapted to control a media gateway for the purpose of setting up and tearing down voice calls from a remote location. This protocol follows the “dumb gateway/intelligent call agent (or softswitch)” network model. It is a much easier protocol to implement than H.323 and requires fewer messages to setup and teardown calls. However, MGCP is not a “network-aware” protocol, i.e., it does not permit a gateway to know about anything except itself, which is a disadvantage in the voice call world. Instead, the gateway relies on the intelligent call agent to be aware of the network. The MGCP protocol only supports a single level of gateway interface, meaning one gateway to another gateway with the call agent as the interface between them. If more than one network must be traversed, the call agent must be programmed to support this function, which is outside the scope of the MGCP protocol. This protocol was found to be lacking in many respects and has been evolved into the current Megaco/H.248 protocol recently approved by the ITU.

The SIP protocol came from the Internet world. Because of its basic “free-form” nature patterned after Hyper Text Transfer Protocol (HTTP), the SIP protocol can and is being adapted to work with voice calls. This protocol carries the “client/server” network model to the extreme with the requirement of SIP users constantly querying SIP servers for information about how to setup and teardown a voice call. SIP is evolving quickly as vendors try to make it inter-operate with PSTN networks and the often multiple, single-function pieces of equipment involved with this protocol. The promise of SIP lies in its ability to implement new call features. However, it does not appear to scale upward efficiently due to the large number of messages required to coordinate the many pieces of single-function equipment and their corresponding call state complexities.

None of these conventional VoIP signaling protocols have all of the advantages that SS7 signaling provides for communicating over the PSTN. While SS7 provides reliable and “feature rich” telephone signaling over the PSTN, its use for telephone signaling over an IP-based network, e.g., VoIP, requires enhancement.

On the PSTN, normal SS7 bearer circuits are commonly numbered between two adjacent switches, i.e., an individual DSO bearer circuit between them has the same CIC number on each end or within each switch. Conversely, VoIP circuits, do not have any such requirement and, in fact, will not be commonly numbered between gateways but instead will be numbered locally. If, for example, an VoIP gateway switch has 480 VoIP ports, the SS7 CIC numbers actually used for the VoIP ports may range from 0 through 16,383, depending on which CIC numbers are currently unused, since all possible SS7 CIC numbers are used no matter how many or how few VoIP ports there are.

Because there cannot be any common numbering between VoIP gateway switches over an IP-based packet network, there exists a need in the art for a system, apparatus and method for dynamically mapping virtual SS7 CICs for use between VoIP gateway switches to allow true SS7 signaling over IP-based packet networks. This dynamic mapping of virtual SS7 CICs must be performed on both VoIP gateway switches.

### DISCLOSURE OF INVENTION

The present invention is a system, apparatus and method for dynamically mapping virtual SS7 CICs for use between Voice over Internet Protocol (VoIP) gateways on IP networks.

A method is disclosed for dynamically mapping virtual Signaling System 7 (SS7) Circuit Identification Codes (CICs) for Voice over Internet Protocol (VoIP) telephone calling between an originating VoIP gateway switch and a terminating VoIP gateway switch over an IP-based packet network. The method may include the terminating VoIP gateway switch receiving an incoming VoIP-enhanced SS7 IAM message having an originating point code (OPC), a destination point code (DPC) and an originating CIC number from the originating VoIP gateway switch for a VoIP telephone call and allocating a terminating CIC number from a CIC available list.

Another method is disclosed for dynamically mapping virtual Signaling System 7 Circuit Identification Codes (CICs) for Voice over Internet Protocol (VoIP) telephone calling between an originating VoIP gateway switch and a terminating VoIP gateway switch over an IP-based packet network. The method may include sending a VoIP-enhanced SS7 IAM message to initiate a VoIP telephone call and dynamically allocating a CIC number to setup the VoIP telephone call. The method may further include returning an SS7 Information message including the dynamically allocated CIC number, performing a reverse mapping based on the SS7 Information message and sending an SS7 completion of test message to indicate the VoIP telephone call is setup.

Methods are disclosed for resolving glare during initiation of a VoIP telephone call between two VoIP gateway switches, each of the two VoIP gateway switches having an originating point code (OPC) and a destination point code (DPC) and having received a VoIP-enhanced SS7 IAM message to initiate the VoIP telephone call, the glare resulting from each received VoIP-enhanced SS7 IAM message including an identical circuit identification code (CIC) number. Methods are also disclosed for setting up a voice over Internet protocol (VoIP) telephone call between an originating VoIP gateway switch and a terminating VoIP gateway switch over an IP-based packet network.

A Voice over Internet Protocol (VoIP) gateway switch for switching VoIP telephone calls over an IP-based packet network is disclosed. The VoIP gateway switch may include a pulse code modulated (PCM)/time division multiplexed (TDM) backplane and a plurality of T1/E1 circuit cards, each in communication with each other over the PCM/TDM backplane, each configured for switching the VoIP telephone calls and configured for dynamically allocating a virtual circuit identification code (CIC) upon receiving a VoIP-enhanced signaling system 7 (SS7) initial address message (IAM) to setup the VoIP telephone calls. The VoIP gateway switch may further include a system bus and a system central processor unit (CPU) board configured to communicate with and control the plurality of T1/E1 circuit cards over the system bus. A VoIP system comprising a plurality of VoIP gateway switches each configured for communication over a public switched telephone network and over an IP-based network is also disclosed.

These system and apparatus embodiments and methods of the present invention will be readily understood by reading the following detailed description in conjunction with the accompanying figures of the drawings.

### BRIEF DESCRIPTION OF DRAWINGS

The drawings illustrate various views or embodiments for carrying out the invention. Additionally, like reference numerals refer to like parts in different views or embodiments.

FIG. 1 is a block diagram of a VoIP gateway switch for use in one or more networks for placing VoIP telephone calls in accordance with the present invention.

FIG. 2 is a block diagram of a system CPU board for use in a VoIP gateway switch in accordance with the present invention.

FIG. 3 is a block diagram of a VoIP gateway switch including the main process layers for implementing a method for dynamically mapping virtual SS7 CIC numbers for use between adjacent VoIP gateway switches over IP-based networks in accordance with the present invention.

FIG. 4 is a block diagram of a VoIP system for placing VoIP telephone calls in accordance with the present invention.

FIG. 5 is a flow chart for a method for setting up a VoIP telephone call in accordance with the present invention.

FIG. 6 is a block diagram illustrating message flow between processes in accordance with a method for glare resolution of the present invention.

### DETAILED DESCRIPTION OF THE INVENTION

The invention includes a system, apparatus and method for dynamically mapping virtual SS7 CICs for use between VoIP gateway switches to allow true SS7 signaling over IP-based packet networks. A system, apparatus and method for sending “SS7 messages” over an IP-based packet network to setup and teardown VoIP telephone calls is disclosed in co-pending U.S. patent application Ser. No. 09/821,256, filed Mar. 29, 2001, the disclosure of which is herein incorporated by reference for all purposes. While the examples below will generally refer to a VoIP “telephone call” for ease of discussion, however, the data that is sent in the VoIP “telephone call” may be telephone voice/audio, video or data sent as IP packets using the RTP packet stream protocol.

The advantages of using “SS7 messages” versus conventional VoIP protocols for setting up and tearing down VoIP telephone calls include: (1) efficient setup and teardown of VoIP telephone calls, (2) signaling may take place through many gateway switches and yet the voice packets can be sent directly between the originating and terminating gateway switches without having to go through all of the intervening gateway switches, (3) routing and billing information about VoIP telephone calls may be acquired and distributed to all of the gateway switches involved, even though the packets may bypass some of the gateway switches, (4) the PSTN may be used on either end of the VoIP call, and the PSTN portion of the VoIP call can also be managed using the same SS7 information contained in the SS7 packets used in the VoIP portion of the telephone call, (5) least cost routing circuit choices may be made during call setup, (6) busy signals may be detected before the call is setup, (7) VoIP calls can be held and re-routed depending on the terminating gateway switch condition stated in the SS7 reply message protocols (presently, holding and re-routing of calls is difficult in any of the conventional VoIP standard or protocols), (8) glare, i.e., the simultaneous conflict of circuit paths, and other telephone call problems, may be resolved without terminating the VoIP telephone call, and (9) the success rate of completing VoIP calls may be increased over conventional VoIP standards and protocols.

The SS7 protocols have either the ITU SS7 or ANSI SS7 standards. Various countries have variations on either the ITU or the ANSI SS7 standards. The SS7 signals are sent on data circuits that in the PSTN are associated with specific bearer channel circuits each of which have a circuit identification code (CIC) number identified by agreement between the two SS7 switches. SS7 standards for the PSTN involve hardware and software that function at multiple layers according to the Open systems Interconnect (OSI) model. In both the ITU and the ANSI SS7 standards, one of the OSI model layers is the ISUP layer. The SS7 ISUP layer software requires all calls to be identified using CIC numbers, in connection with the Originating Point Code (OPC) which uniquely identify the originating gateway switch and the Destination Point Code (DPC) which uniquely identify the destination gateway switch in order to operate properly over the PSTN. The Point Codes are uniquely assigned to each switch on PSTN telephone networks.

VoIP gateway switches, as well as any other computer equipment attached to the Internet are assigned unique IP addresses. These IP addresses can be used as OPC and DPC identification numbers to the ISUP layer software with appropriate mapping protocols such as M3UA. Since VoIP telephone packets can be sent by many paths over an IP-based network, such as the Internet, VoIP telephone calling may be though of as being “circuit-less”. In contrast, voice transmission over the PSTN is “circuit-based”.

In order to use SS7 signaling on VoIP telephone calls, the originating and terminating gateway switches using VoIP and SS7 software must configure VoIP CIC numbers as well as OPC and DPC numbers to the ISUP layer that are usable between the gateway switches. Because VoIP telephone calling is inherently “circuit-less”, the originating and terminating VoIP gateway switch software must dynamically map VoIP circuits as used by the VoIP gateway switch software into the VoIP ISUP CIC circuit numbers with which the ISUP software has been configured in order to make the VoIP “circuit-less” network appear to be “circuit-based”.

The CIC number presents the biggest problem with using SS7 protocols over IP-based packet networks. SS7 only allows 2¹⁴, or 16,384, possible CIC numbers. SS7 in the PSTN expects CIC numbers to be within the range of 0 to 16383 because there are a limited number of bearer channels associated with the redundant SS7 data channels. It is possible to create a CIC number for each circuit within VoIP gateway switches that are within the limit of 16,384. These switch specific CIC numbers will be meaningless between VoIP gateway switches because the IP-based packet network over which they communicate is inherently “circuit-less” because the exact circuits or paths that the VoIP packets follow after they leave the switches are not known to the VoIP gateway switches as they are in the PSTN context. What is important is the IP address of the originating VoIP gateway switch and the IP address of the terminating VoIP gateway switch, so that the packets will travel to and from the exact VoIP gateway switches involved in the VoIP telephone call by whatever path is actually taken.

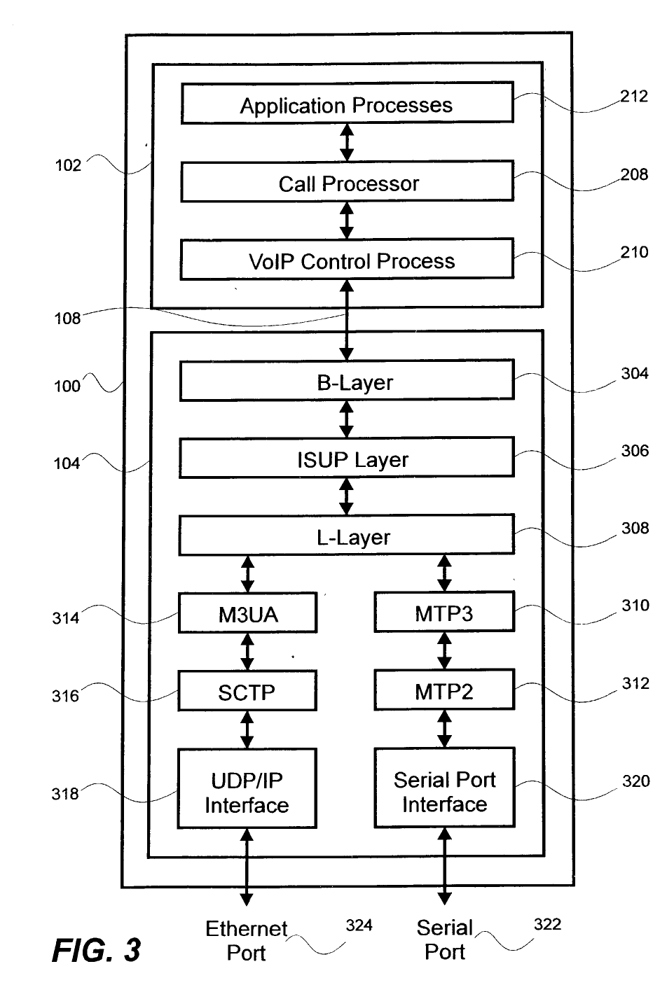

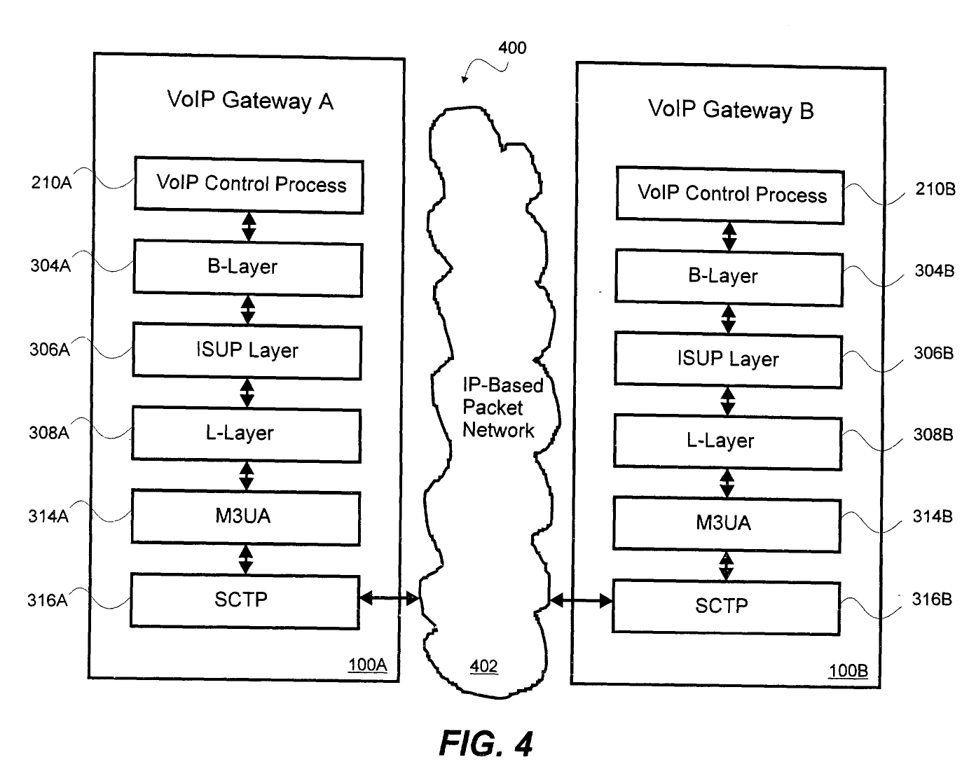

The solution to the CIC number problem according to the present invention is to fool the ISUP layer software so that the call will be processed according to SS7 protocols. In order to accomplish this solution a layer of software is inserted above and below the ISUP layer in the OSI software model. These two additional layers are used to map incoming SS7 messages, such as the IAM, to SS7 required CIC codes, etc. that are recognizable to the ISUP layer and again map the ISUP layer information back to codes that the VoIP gateway switch will recognize on the IP-based packet network side of the ISUP layer. This solution is discussed in further detail with reference to FIGS. 3 and 4, below.

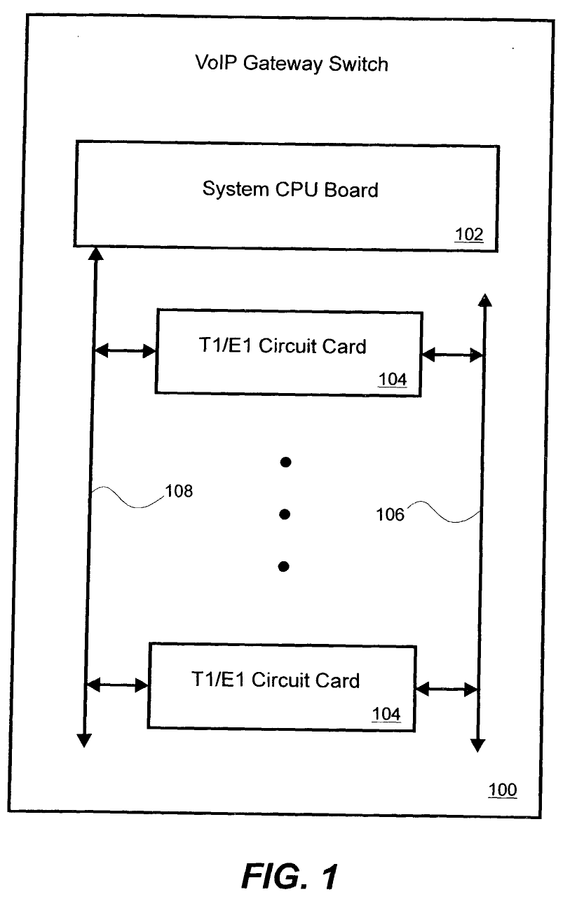

FIG. 1 is a block diagram of a VoIP gateway switch 100 for use in one or more networks (not shown) for placing VoIP telephone calls in accordance with the present invention. VoIP gateway switch 100 includes a system central processing unit (CPU) board 102 and a plurality of T1/E1 circuit cards 104. Each T1/E1 circuit card 104 is connected to a pulse code modulated (PCM)/time division multiplexed (TDM) backplane 106. Each T1/E1 circuit card 104 may also include memory (not shown) for storing computer programmed instructions. Additionally each T1/E1 circuit card is configured to interface with both an IP-based packet network (e.g., the Internet) and with circuit switched trunk lines (e.g., the PSTN). System CPU board 102 communicates with each T1/E1 circuit card 104 through a system bus 108. The system bus 108 may be an Arcnet backplane as known to one of ordinary skill in the art. The CPU board 306 does not communicate over the PCM/TDM backplane 106.

Pulse code modulation (PCM) is the name of the G.711 voice codec algorithm that is used to convert analog voice into digital data. PCM converts analog voice into 8,000 8-bit data samples every second. There are at least two implementations of PCM. The A-law PCM is used throughout most of the world. The mu-law PCM is used throughout North America and Japan.

Time Division Multiplexing (TDM) is the technique by which circuit-switched networks, such as the PSTN, carry multiple voice calls over a single physical circuit. This is accomplished by transmitting individual PCM samples from multiple calls in a serial fashion 8,000 times per second for 24 calls on a T1 circuit and for 30 or 31 calls on an E1 circuit.

System CPU board 102 may include a processor (not shown) for executing computer programmed instructions and memory (not shown) for storing computer programmed instructions. System CPU board 102 may also be configured for communicating with an IP-based packet network (not shown for clarity). The memory on system CPU board 102 and T1/E1 circuit cards 104 may be read only memory (ROM), electrically programmable ROM (EPROM), static random access memory (SRAM), dynamic random access memory (DRAM), synchronous DRAM (SDRAM), or any other suitable memory for storing computer program instructions.

VoIP gateway switch 100 may preferably comprise Specialty Telecommunications Exchange (STX™) switch or Integrated Protocols and Applications Xchange™ (IPAX™) gateway, Class 4, tandem switches, available from NACT Telecommunications, Inc., 191 West 5200 North, Provo, Utah, 84604, the assignee of the present invention. An STX™ or IPAX™, as of this writing, is configurable from 2 to 80 T1 spans or 2 to 64 E1 spans (48 to 1920 ports) in a single card cage. Up to 4 STX™ or IPAX™ tandem switches may be connected together using a Master Control Unit (MCU™) also available from NACT Telecommunications, Inc. However, any VoiP gateway switch 100 capable of performing the functions described herein may be used consistent with the present invention. The term “STX or IPAX compatible” gateway switch, as used herein refers to any VoIP gateway switch capable of performing the functions of a VoIP gateway switch as described herein including an STX™ or IPAX™, class 4, tandem switch. Although not illustrated, a VoIP gateway switch 100 may also include input/output devices, e.g., a monitor, keyboard, mouse, etc., for use by an operator or technician. Furthermore, a VoIP gateway switch 100 may also be configured for remote analysis, troubleshooting, and servicing, from any remote location over the PSTN or IP networks to which it is connected.

VoIP gateway switch 100 is configured to send two kinds of packets over an IP-based packet network. The first kind of packet is an enhanced SS7 signaling packet, which carries the conventional SS7 telephony information (e.g., destination telephone number) and additional (or enhanced) signaling information needed for interaction over an IP-based packet network between VoIP gateway switches 100. Such additional or enhanced signaling information may be included in the Access Transport Field as defined in the SS7 protocol. The term “enhanced SS7 signaling packet”, as used herein, is inclusive of “enhanced SS7 signaling initiate packet”, “enhanced SS7 signaling reply packet”, “enhanced SS7 signaling handshake packet”, “SS7 signaling terminate packet” and “enhanced SS7 signaling terminate packet” as further defined herein.

The second kind of packet sent and received by a VoIP gateway switch 100 is a voice packet, a plurality of which are used to carry the telephone call conversation. It will be recognized by one of ordinary skill in the art that an enhanced SS7 signaling packet may be broken up into a plurality of enhanced SS7 signaling packets without departing from the scope of the invention. For simplicity of discussion, a single enhanced SS7 signaling packet containing all of the necessary information for a particular signaling task is assumed in this discussion.

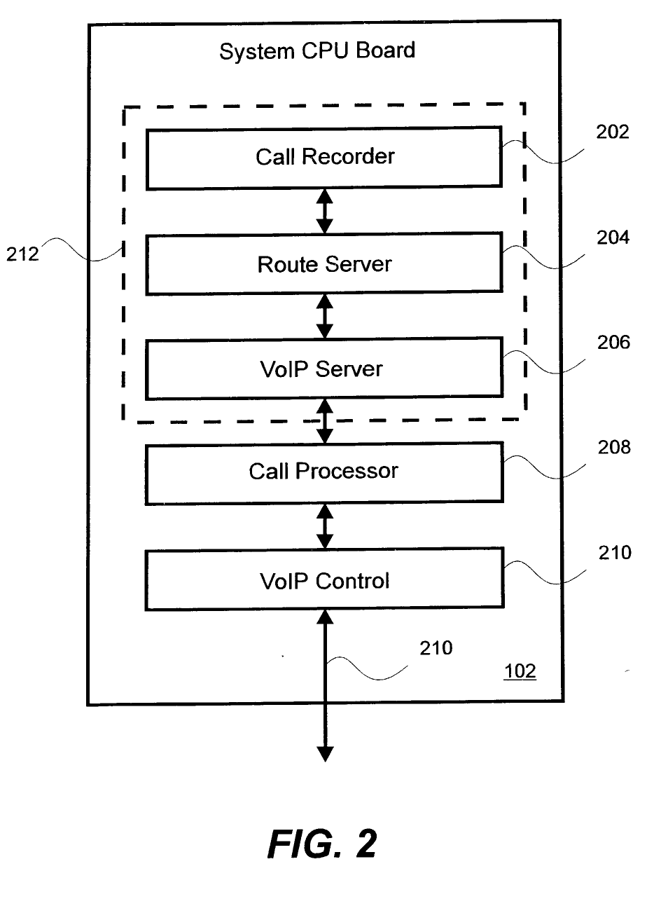

FIG. 2 is a block diagram of a system CPU board 102 for use in a VoIP gateway switch 100 in accordance with the present invention. System CPU board 102 may include many processes implemented either in software or hardware. In a preferred embodiment, system CPU board 102 include call recorder 202, route server 204, VoIP server 206, call processor 208 and VoIP control 210. Collectively, call recorder 202, route server 204 and VoIP server 206 may be referred to as “application processes” 212.

Call recorder 202 creates call records for use in billing customers and processes various messages during the life of a call. Route server 204 routes a call to an outbound trunk based upon various criteria, such as the route partition in use by the caller, the destination number, time-of-day, etc. Route server 204 may also be responsible for pre-routing incoming VoIP calls and bidding for management of incoming VoIP calls. VoIP server 206 receives all incoming VoIP Initial Address messages from the B-layer software (see discussion below) and requests each VoIP gateway switch 100 to “bid” for the incoming VoIP call. VoIP server 206 may also track the VoIP port license and vocoder type license use among all VoIP gateway switches 100 and prevent the use of more vocoders than there are licenses for. VoIP server 206 may also compute the available vocoder list based upon port license use and the permitted vocoder types.

Call processor 208 may interface the VoIP gateway application processes 212 with the “protocol control” software that controls individual trunks and trunk groups. Call processor 208 knows about calls and how calls proceed and should operate and how they interact with trunks. Call processor 208 supplies a common interface to the “protocol control” processes so they can perform their protocol-specific functions and insulate them from the call processor 208.

VoIP control 210 controls the VoIP channels and their assignment as inbound or outbound trunks for VoIP calls. VoIP control 210 interprets the VoIP-enhanced SS7 messages used to communicate VoIP call setup and teardown with other STX gateway switches. VoIP Control 210 receives the VoIP Set Up Call message and saves the VoIP information passed in the SS7 IAM “Access Transport” field for later processing. This information is the originating VoIP gateway voice RTP, RTCP and T.38 FAX RTP ports (IP address+UDP port number) and a list of permitted and available vocoder types and silence suppression indicators.

FIG. 3 is a block diagram of a VoIP gateway switch 100 including the main process layers for implementing a method for dynamically mapping virtual SS7 CIC numbers for use between adjacent VoIP gateway switches 100 over IP-based networks in accordance with the present invention. VoIP gateway switch 100 includes a system CPU board 102 and at least one T1/E1 circuit card 104. System CPU board 102 may include application processes 212, call processor 208 and VoIP control 210.

T1/E1 circuit card 104 may include various software process layers. In a preferred embodiment, T1/E1 circuit card 104 includes B-layer 304, ISUP layer 306, L-layer 308, MTP3 layer 310, MTP2 layer 312, M3UA layer 314 and SCTP layer 316. T1/E1 circuit card 104 may also include UDP/IP interface 318 and serial port interface 320. B-layer 304 includes computer program instructions in software or hardware for mapping SS7 messages for VoIP calls between the ISUP layer 306 and the VoIP control 210 located within the system CPU board 102. Specifically B-layer 304 maps between the ISUP circuit number used in the ISUP layer 306 and the VoIP handle used by the VoIP control 210 located within the system CPU board 102. B-layer 304 does not map or change in any way the ISUP circuit number in the SS7 messages for non-VoIP calls. As shown in FIG. 3 the B-layer 304 is located above the ISUP layer 306 and interfaces between the ISUP layer 306 and the VoIP control 210 for a VoIP gateway switch 100. The B-layer 304 maps between the gateway application software “switch / slot/span/channel” trunk representation and an ISUP circuit number among many other things.

ISUP layer 306 includes computer program instructions in software or hardware for implementing the ISDN User Part (ISUP) which is the network signaling protocol that sets up and tears down calls in the PSTN network using messages transmitted between switches over the SS7 data network. The ISUP protocol is a connection-oriented or circuit-oriented protocol, meaning that ISUP messages between systems are about connections or circuits between them. ISUP messages do not stand on their own, meaning multiple messages will be sent and received concerning the same connection or circuit in a specific order, each time the circuit is used for a call. ISUP messages are transported over the SS7 network by the MTP3 layer 310 or the M3UA layer 314 layers. A preferred embodiment of ISUP layer 306 is Trillium ISUP, which is portable C source software for implementing the SS7 ISUP protocol. Trillium ISUP is available from Trillium Digital Systems, Inc., 12100 Wilshire Blvd., Suite 1800, Los Angeles, Calif. 90025-7118.

L-layer 308 includes computer program instructions in software or hardware for mapping the OPC, DPC and CIC numbers in SS7 messages between those required by the local VoIP gateway switch 100 for the internal management of its own VoIP calls and those required by the remote VoIP gateway switch 100 for the internal management of its VoIP calls. The mapping occurs for messages between ISUP layer 306 and M3UA layer 314. The L-layer is located below the ISUP layer 306 and interfaces to the M3UA layer 314 for VoIP SS7 processing and also interfaces to the MTP3 layer 310 for normal PSTN SS7 processing. The L-layer 308 works together with the B-layer 304 to map between the “circuit-less” or virtual VoIP channels and predefined local ISUP circuits reserved for this purpose. The B-layer 304 and L-layer 308 work together to preserve the SS7 circuit numbers sent by other VoIP gateway switches for VoIP calls so that both the originating and the terminating gateway switch SS7 protocol stacks use the predefined, local ISUP circuit numbers reserved for use with virtual VoIP channels.

MTP3 layer 310 includes computer program instructions in software or hardware for implementing the Message Transfer Part 3 (MTP3) protocol that routes SS7 messages given to it over the SS7 data network. MTP3 layer 310 is aware of SS7 point codes and how to route messages to them. When MTP3 layer 310 has selected a route to a particular point code, it uses the MTP2 layer 312 to transmit the message to the next system in the SS7 data network. MTP2 layer 312 includes computer program instructions in software or hardware for implementing the Message Transfer Part 2 (MTP2) protocol that transmits and guarantees receipt of a SS7 message between two adjacent systems in the SS7 data network using the traditional SS7 A-links or F-links, as known to one of ordinary skill in the art. MTP2 layer 312 interfaces with serial port interface 320 which, in turn, communicates with serial port 322. Serial port interface 320 may be implemented, for example and not by way of limitation, using V×Works 860 Device Driver from Wind River, 500 Wind River Way, Alameda, Calif. 94501.

M3UA layer 314 includes computer program instructions in software or hardware for implementing the MTP3 User Adaption (M3UA) layer protocol that adapts SS7 MTP3 messages for transport over an IP network using the SCTP layer 316. M3UA layer 314 protocol is aware of SS7 point codes and circuits. M3UA layer 314 translates point codes into IP addresses for SS7 message transport across an IP-based packet network. SCTP layer 316 includes computer program instructions in software or hardware for implementing the Stream Control Transmission Protocol used for transmitting SS7 messages over an IP-based packet network. SCTP layer 316 interfaces with UDP/IP interface 318 which, in turn, communicates with Ethernet port 324. UDP/IP interface 318 may be implemented, for example and not by way of limitation, using V×Works UDP/IP from Wind River, 500 Wind River Way, Alameda, Calif. 94501.

Referring to FIG. 4, a block diagram of a VoIP system 400 for placing VoIP telephone calls, is shown in accordance with the present invention. VoIP system 400 includes two VoIP gateway switches, an originating VoIP gateway switch 100A and a terminating VoIP gateway switch 100B communicating over an IP-based packet network 402. Originating VoIP gateway switch 100A may include VoIP control 210A, B-layer 304A, ISUP layer 306A, L-layer 308A, M3UA layer 314A and SCTP layer 316A. Similarly, terminating VoIP gateway switch 100B may include VoIP control 210B, B-layer 304B, ISUP layer 306B, L-layer 308B, M3UA layer 314B and SCTP layer 316B.

An originating VoIP telephone call is processed when a terminating VoIP gateway switch 100B receives a standard SS7 IAM message that has been augmented with VoIP information from the originating VoIP gateway switch to form a “VoIP-enhanced” SS7 IAM message. The VoIP-enhanced SS7 IAM message is received by M3UA layer 314B for a VoIP telephone call. This VoIP-enhanced SS7 IAM message contains the OPC of the originating. VoIP gateway switch 100A, the DPC of the terminating VoIP gateway switch 100B and a CIC number from the originating VoIP gateway switch 100A. If the incoming call is for a VoIP telephone call, the ISUP layer 306B must be given a VoIP CIC number that maps into a local ISUP circuit number reserved for VoIP calls.

The L-layer 308B receives the VoIP-enhanced SS7 IAM message from the M3UA layer 314B. It detects this is an “incoming” VoIP-enhanced SS7 IAM message received from an originating VoIP gateway switch 100A, allocates a local CIC number from a CIC available list and then creates a “CIC mapping” record into which it saves the SS7 message OPC, DPC and CIC fields along with the local CIC number. There are two CIC available lists, an odd available list and an even available list. The odd available list contains all odd CIC numbers that are not currently in use. Similarly, the even available list contains all even CIC numbers that are not currently in use.

The L-layer 308B maps the OPC, DPC and CIC fields into the local information acceptable to the ISUP layer 306B and then passes this “mapped” SS7 IAM message through the ISUP layer 306B to the B-layer 304B. When the L-layer 308B receives a VoIP-enhanced SS7 lAM message for an incoming VoIP call from the M3UA layer 314B , it compares the message DPC with the message OPC and allocates a CIC mapping record from the head of either the even or the odd CIC available list of 0 through 16,383 possible CIC codes according to the following decision rules:

1. If the OPC number is less than the DPC number, the decision will be from the odd available list.

2. If the OPC number is greater than the DPC number, the decision will be from the even available list.

Both the originating VoIP gateway switch 100A and the terminating VoIP gateway switch 100B follow this process and, therefore, know from these rules which “available list” to choose the CIC number from. This prevents glare by determining which VoIP gateway switch 100A or 100B has control of the creation of a CIC code that both VoIP gateway switches understand. For further detailed discussion regarding glare resolution see below.

The ISUP layer 306B passes the processed IAM message information to the B-layer 304B. The B-layer 304B maps the information into the local CIC codes that the terminating VoIP gateway switch 100B needs to setup the call. This accomplishes the mapping of a remote CIC to a local CIC when receiving a VoIP-enhanced SS7 IAM message for a VoIP call from an originating VoIP gateway switch 100A.

From this point forward, the VoIP call is handled just as any other SS7 call. The call is processed and the terminating VoIP gateway switch 100B sends an SS7 INF (with VoIP information) message to the originating VoIP gateway switch 100A and the VoIP telephone call is setup. The telephone voice/audio, video or data is sent as IP packets using the RTP packet stream protocol. When either the originating VoIP gateway switch 100A or terminating VoIP gateway switch 100B notifies the other, the call is properly torn down. The above example of setting up a VoIP telephone call is explained in greater detail below.

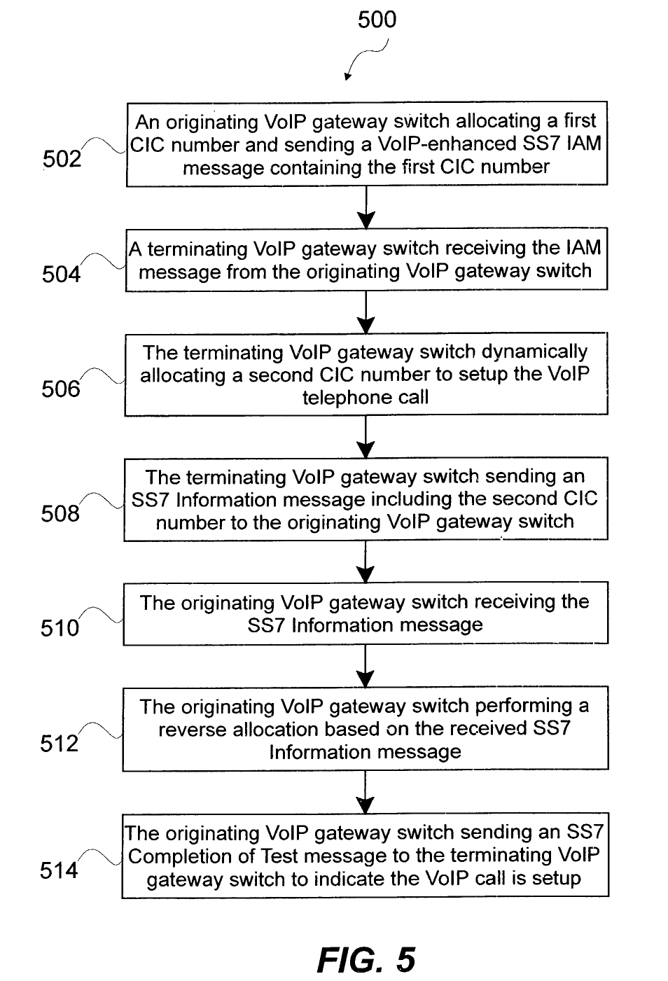

FIG. 5 is a flow chart for a method 500 for setting up a VoIP telephone call in accordance with the present invention. Method 500 may include an originating VoIP gateway switch 100A allocating 502 a first CIC number and sending a VoIP-enhanced SS7 IAM message containing the first CIC number. Method 500 may further include a terminating VoIP gateway switch 100B receiving 504 the VoIP-enhanced SS7 IAM message from the originating VoIP gateway switch. The first CIC number may be allocated from among the available local CIC numbers of the originating VoIP gateway switch 100A. Method 500 may further include the terminating VoIP gateway switch 100B dynamically allocating 506 a second CIC number to setup the VoIP telephone call and sending 508 an SS7 Information message back to the originating VoIP gateway switch 100A. The second CIC number may be selected from among the available local CIC numbers of the terminating VoIP gateway switch 100B. Method 500 may further include the originating VoIP gateway switch 100A receiving 510 the SS7 Information message and performing 512 a reverse mapping based on the received SS7 Information message. Method 500 may further include the originating VoIP gateway switch sending 514 an SS7 Completion of Test message to the terminating VoIP gateway switch to indicate the VoIP call is set up.

An explanation of method 500 follows. Reference to drawing FIGS. 2-4 will be made throughout the discussion. The VoIP telephone call described below assumes communication over an IP-based packet network 402, such as the Internet, between two VoIP gateway switches, an originating VoIP gateway switch 100A and a terminating VoIP gateway switch 100B, see FIG. 4. When an originating VoIP gateway switch 100A sends 502 a VoIP-enhanced SS7 IAM message, the originating VoIP gateway B-layer 304A allocates a pre-defined “CIC mapping” record that contains an internal VoIP local ISUP circuit number and a CIC for which the ISUP layer 306A has been configured. B-layer 304A assigns the local VoIP CIC as the “remote CIC” that will be used within the SS7 messages sent to the terminating VoIP gateway switch 100B. The B-layer 304A assigns the VoIP-enhanced SS7 IAM message the “local VoIP CIC” number from the CIC Mapping record and passes the VoIP-enhanced SS7 IAM message to the ISUP layer 306A. The VoIP-enhanced portion of the SS7 IAM message includes five pieces of information, the RTP, RTCP and T.38 FAX RTP ports (IP address+UDP port number), and a list of available vocoders and silence suppression indicator that the originating VoIP gateway switch 100A can support. The B-layer 304A copies this packed information into the optional Access Transport field in the IAM message as defined in the SS7 signaling protocol.

The L-layer 308A in the originating VoIP gateway switch 100A receives the VoIP-enhanced SS7 IAM message from the ISUP layer 306A and using the CIC Mapping record maps the ISUP DPC and CIC numbers in the IAM message into the remote DPC and CIC numbers to be sent to the terminating VoIP gateway switch 100B. On the originating VoIP gateway switch 100A, these two CIC numbers, local VoIP and remote, are identical.

When the terminating L-layer 308B of a terminating VoIP gateway switch 100B receives 504 the VoIP-enhanced SS7 IAM message from the M3UA layer 314B layer, it dynamically allocates 506 a CIC number to setup the VoIP telephone call. More specifically, the terminating L-layer 308B of a terminating VoIP gateway switch 100B allocates a predefined “CIC Mapping” record used to map between the originating VoIP gateway SS7 CIC number and the terminating VoIP gateway switch internal VoIP SS7 CIC number. The CIC Mapping record contains a VoIP ISUP circuit number reserved for VoIP calls. The L-layer 308B saves the original DPC and CIC numbers from the VoIP-enhanced SS7 IAM message, populates the mapping record with their local VoIP equivalents based upon the pre-defined VoIP ISUP circuit number, replaces the originals in the VoIP-enhanced SS7 IAM message with the terminating VoIP PC and local CIC numbers, and then passes the VoIP-enhanced SS7 IAM message up to the ISUP layer 306B.

The ISUP layer 306B converts the OPC, DPC and CIC numbers in the VoIP-enhanced SS7 IAM message into a “switch VoIP ISUP circuit number”, composed of “switch /slot/span/channel”, which is then passed to the B-layer 304B. This switch VoIP ISUP circuit number is actually a pre-defined local VoIP ISUP circuit number created expressly for VoIP calls and is one of 16,384 such numbers created for this purpose.

Unfortunately, the B-layer 304B cannot pass this local VoIP ISUP circuit number to the VoIP control 210B because it is not a real switch circuit number for a VoIP channel, mainly because there is no actual VoIP channel yet in use. This means the B-layer 304B must pass this local VoIP ISUP circuit number as a “VoIP handle”, which appears similar to a switch circuit number, up to the VoIP control 210B.

Referring also to FIG. 2, in conjunction with the route server 204 and the VoIP control 210, the VoIP server 206 may determine the terminating VoIP gateway switch 100B (if more than one) that should handle the incoming VoIP call, selects the vocoder type and silence suppression from the list of available vocoder types and silence suppression indicators sent by the originating VoIP gateway switch 100A, and passes management of the VoIP call to the selected terminating VoIP gateway switch 100B. The VoIP control 210B on the selected terminating VoIP gateway switch 100B may select the actual VoIP channel to use and create a means of mapping between the VoIP handle and the actual VoIP channel. The VoIP control 210B in the system CPU board 102 and the B-layer 304B in the T1/E1 board 104 with the ISUP layer 308B may communicate information about a VoIP call using the VoIP handle. The VoIP Control 210B and the other VoIP application processes (e.g., call recorder 202, route server 204 and VoIP server 206) may use the actual VoIP channel to communicate information about the VoIP call.

In this manner, each process layer, the L-layer 308, the ISUP layer 306, the B-layer 304, the VoIP control 210, the VoIP server 206, the route server 204 and the call recorder 202 may use information appropriate to itself. The L-layer 308 will map remote VoIP gateway SS7 message OPC, DPC and CIC numbers and local VoIP gateway OPC, DPC and CIC numbers reserved for VoIP calls. The ISUP layer 306 will map local VoIP OPC, DPC and CIC numbers and local VoIP ISUP circuit numbers. The B-layer 304 will map local VoIP ISUP circuit numbers and VoIP handles, and the VoIP Control 210 will map VoIP handles and actual VoIP channels.

VoIP control 210B selects an appropriate vocoder type from those offered by the originating VoIP gateway switch 100A using a prioritized list of its own vocoder type possibilities. VoIP control 210B then sends a “VoIP Open Channel” message to the T1/E1 circuit card 104 where a channel is opened on the VoIP module using the selected vocoder type. After the VoIP module opens the channel, the T1/E1 circuit card 104 sends an “Open VoIP Channel Acknowledgment” back to the VoIP control 210B. VoIP control 210B then sends an “Activate VoIP Channel” message to the T1/E1 circuit card 104 containing the originating VoIP gateway voice transport RTP, RTCP, and T.38 FAX RTP ports. The T1/E1 circuit card 104 activates the channel and then sends an “Activate VoIP Channel Acknowledgment” message back to the VoIP control 210B containing the terminating VoIP gateway voice RTP, RTCP and T.38 FAX RTP ports, which VoIP control 210B saves for later use. Lastly, the VoIP control 210B assembles a VoIP Send VoIP Parameters message, that is actually an SS7 “Information” message containing the VoIP handle and the terminating VoIP gateway's RTP, RTCP and T.38 FAX RTP ports and the selected vocoder type and silence suppression indicator, and then sends the message to the B-layer 304B in the T1/E1 circuit card 104 containing the SS7 stack.

The B-layer 304B maps the VoIP handle back to the VoIP ISUP circuit number, assembles a proper SS7 Information message with the VoIP information in the optional SS7 “Access Transport” field, and then passes the message down to the ISUP layer 306B. The ISUP layer 306B maps the VoIP ISUP circuit number in the message into the OPC, VoIP DPC and VoIP CIC numbers, and passes the SS7 message to the L-layer 308B. The L-layer 308B finds the CIC Mapping record for the OPC, VoIP DPC and VoIP CIC numbers, and replaces the DPC and CIC numbers in the SS7 Information message with the saved DPC and CIC numbers of the originating VoIP gateway switch 100A. It then passes the SS7 Information message to the M3UA layer 314B layer for transport back 508 to the originating VoIP switch 100A.

The terminating VoIP control 210B creates a sequence number for the inbound VoIP channel and through the call processor (208 not shown in FIG. 4, see FIG. 2) sends an “Off-hook” message to the call recorder (202 not shown in FIG. 4, see FIG. 2). In response to a returned ANI Validation request message, the call processor (208 not shown in FIG. 4, see FIG. 2) sends an “ANI Validation” request message to the ANI server process (not shown) where normal application call processing takes over.

The originating VoIP gateway switch 100A receives 510 the SS7 Information message and performs 512 the mapping in reverse, passing the Information message through each layer until it reaches the VoIP control 210A as a VoIP Returned Parameters message. VoIP control 210A then activates its own VoIP channel using the three RTP ports and the vocoder type and silence suppression indicator passed in the original returned SS7 Information message.

At this point any voice data from either the originating VoIP gateway switch 100A or terminating VoIP gateway switch 100B is being passed back and forth between the two VoIP gateway switches 100A, 100B through the RTP or T.38 FAX ports while the RTCP port keeps each side informed about congestion. The originating VoIP gateway switch 100A then sends 514 back a VoIP Continuity Success message as an SS7 Completion of Test to inform the terminating VoIP gateway switch 100B it has been successful at activating its VoIP channel. Both VoIP gateway switches 100A, 100B then connect their talk paths and the VoIP call has now been set up through the IP-based packet network 402.

Tearing down the call is performed with SS7 messages with each layer and process performing its own mapping as SS7 messages pass through. When an SS7 Release Complete message passes through, the layer to last use the mapping information deletes the CIC Mapping record and returns the VoIP ISUP circuit number back to the available pool.

When two VoIP gateway switches 100 simultaneously choose the same ANSI SS7 circuit identification code (CIC) for use in calls between them, a “glare” situation is created. The following discussion describes how this situation is resolved in accordance with the present invention. One of the criteria for glare resolution according to the method of the present invention is that the two VoIP gateway switches 100 should equally bear the burden of resolution, i.e., the processing load should be shared between them instead of the burden always being borne by one gateway to its detriment in processing speed. The method of the present invention will not only share the burden equally between the two VoIP gateway switches 100, but will allow both the two VoIP gateway switches 100 to simultaneously know which one will get to keep its call and which one will have to reattempt its call. All glare resolution with regard to a call reattempt is performed on a single VoIP gateway switch (originating or terminating) without any interaction with the other (of the originating or terminating) VoIP gateway switch.

In the case where two VoIP gateway switches each independently start different calls by sending each other a VoIP-enhanced SS7 IAM message and both gateway switches randomly and independently choose the same CIC number for both calls (glare), the gateway's switch processes must resolve the “glare” situation so that one VoIP gateway switch will know it can continue with the call and the other VoIP gateway switch will know that it must restart its call without any interaction between them.

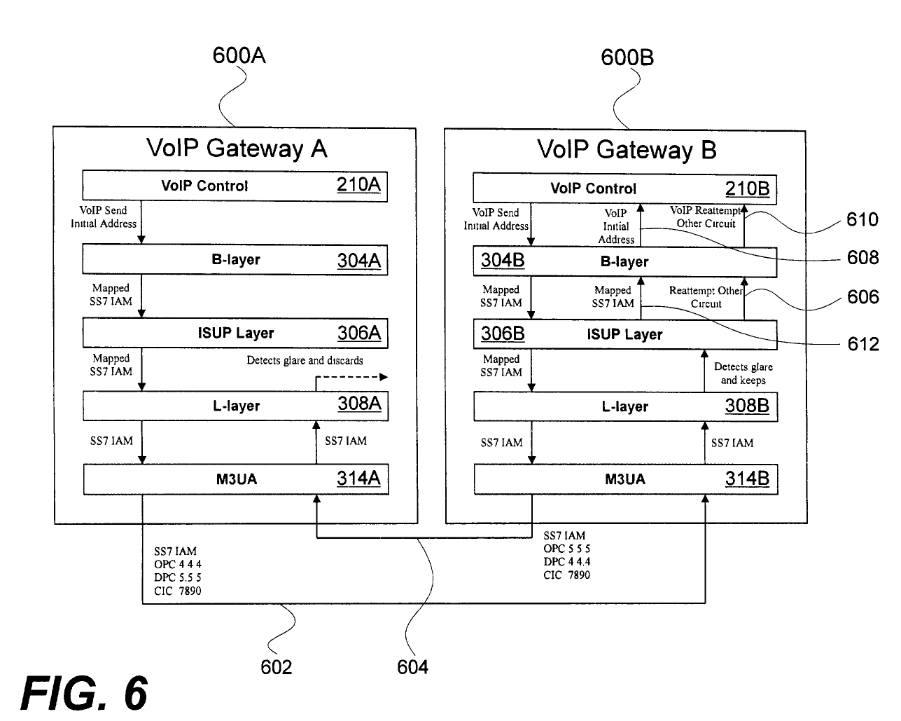

FIG. 6 is a block diagram illustrating message flow between processes in accordance with a method 600 for glare resolution of the present invention. FIG. 6 shows first VoIP gateway switch 600A and second VoIP gateway switch 600B. As shown in FIG. 5, each VoIP gateway switch 600A, 600B independently initiates a VoIP telephone call from its VoIP control 210A, 210B, respectively, by each sending a VoIP-enhanced SS7 IAM message 602, 604, respectively, each having identical CIC 7890. When two VoIP gateway switches 600A, 600B simultaneously choose the same ANSI SS7 CIC for use in calls between them, a glare situation is created. The following discussion describes how this situation is resolved according to the method 600 of the present invention. When resolving glare, it is desirable that the both VoIP gateway switches 600A, 600B should equally bear the burden of resolution, i.e., the processing load should be shared between them instead of always being borne by one VoIP gateway switch 600A or 600B to its detriment in processing speed. According to method 600, the burden is shared equally between the both VoIP gateway switches 600A, 600B but will allow both VoIP gateway switches 600A, 600B to simultaneously know which one will get to keep its call and which one will have to reattempt its call. All glare resolution with regard to a call reattempt is performed on a single VoIP gateway switch 600A or 600B without any interaction with the other VoIP gateway switch 600A or 600B.

To illustrate the glare problem, assume Table 1, below, shows the CIC Mapping records for both VoIP gateway switches 600A, 600B at the time they both transmit their VoIP-enhanced SS7 IAM messages with the SS7 Access Transport field populated with VoIP information. As illustrated by the message flow (arrow-headed lines 604 and 602 originating from VoIP control 210A an 210B, respectively) in FIG. 6, when the VoIP-enhanced SS7 IAM messages are received by their respective recipient VoIP gateway switches 600A, 600B, the L-layer 308A and 308B of each VoIP gateway switch will discover CIC 7890 is already in use, and thus a glare situation exists.

TABLE 1

| VoIP Gateway Switch A | | Index | VoIP Gateway Switch B | |
|---|---|---|---|---|
| VoIP PC | 4.4.4 | 1 | VoIP PC | 5.5.5 |
| VoIP CIC | 7890 | | VoIP CIC | 7890 |
| Remote PC | 5.5.5 | 2 | Remote PC | 4.4.4 |
| Remote CIC | 7890 | | Remote CIC | 7890 |
| VoIP Handle | 2/13/101/87 | 3 | VoIP Handle | 3/20/101/239 |
| VoIP ISUP | 0/100/30/210 | 4 | VoIP ISUP Circuit | 0/100/30/210 |
| Circuit Number | | | Number | |
| Glare Handle | 0/0/0/0 | | Glare Handle | 0/0/0/0 |

In order to resolve the situation in an equitable manner, so that each VoIP gateway switch 600A, 600B is not unduly burdened, the VoIP gateway switches 600A, 600B compare their own SS7 point code with the remote point code (i.e., the other VoIP gateway point code) and handle the incoming VoIP-enhanced SS7 IAM message based, for example and not by way of limitation, upon the decisions provided in the following Table 2.

TABLE 2

| | CIC is Even | CIC is Odd |
|---|---|---|
| OPC < DPC | Discard Message | Keep Message |
| OPC > DPC | Keep Message | Discard Message |

Continuing with the example, VoIP gateway switch 600A, has point code (PC), 4.4.4, which is less than the remote PC, 5.5.5 (VoIP gateway switch 600B). Additionally, the CIC 7890 is even, so VoIP gateway switch 600A discards the VoIP-enhanced SS7 IAM message its L-layer 308A just received from the M3UA layer 314A. VoIP gateway switch 600B has PC, 5.5.5, which is greater than the remote PC 4.4.4 (VoIP gateway switch 600A) and the CIC 7890 is even so, VoIP gateway switch 600B keeps the VoIP-enhanced SS7 IAM message its L-layer 308B just received. This means that the outgoing VoIP-enhanced IAM message 602 from VoIP gateway switch 600A will be processed by VoIP gateway switch 600B. It also means that VoIP gateway switch 600B will reinitiate another IAM transmission for its outgoing call. For this example, VoIP gateway switch 600A will not have to do anything more than discard the incoming VoIP-enhanced SS7 IAM message to resolve the glare situation. Of course, the inequality signs in Table 2 may be reversed, or “Even” may be exchanged with “Odd” in Table 2 and still be within the scope of the present invention.

VoIP gateway switch 600B may then proceed to process the incoming VoIP-enhanced SS7 IAM message 602 by manipulating the CIC Mapping record fields in, for example and not by way of limitation, the following manner:

(1) Copy the VoIP handle into the glare handle field.

(2) Delete index 3.

(3) Copy the VoIP ISUP Circuit Number into the VoIP handle field.

(4) Create a new index 3.

This results in a CIC Mapping record for each VoIP gateway switch 600A, 600B that appears as shown below in Table 3.

TABLE 3

| Index | VoIP gateway switch 400B | |
|---|---|---|
| 1 | VoIP PC | 5.5.5 |
| | VoIP CIC | 7890 |
| 2 | Remote PC | 4.4.4 |
| | Remote CIC | 7890 |
| 3 | VoIP Handle | 0/100/30/210 |
| 4 | VoIP ISUP Circuit Number | 0/100/30/210 |
| | Glare Handle | 3/20/101/239 |

At this point the L-layer 308B of VoIP gateway switch 600B passes the VoIP-enhanced SS7 IAM message up to the ISUP layer 306B. The ISUP layer 306B will detect the glare situation and since it is configured to resolve glare in favor of the incoming VoIP-enhanced SS7 IAM message, will pass it on through to the B-layer 304B. The ISUP layer 306B also generates an SS7 Reattempt Other Circuit message 606 for the Local VoIP ISUP Circuit Number “0/100/30/210”, which is passed up to the B-layer 304B.

The B-layer 304B receives the mapped SS7 IAM message 612, finds that it has a CIC Mapping record, and converts the CIC Mapping record into a VoIP Initial Address message 608, which it sends to the VoIP control 210B. The B-layer 304B may then receive the SS7 Reattempt Other Circuit message 606, finds the CIC Mapping record using index 3, uses the glare handle value as the VoIP Handle in the VoIP Reattempt Another Circuit message 610, zeros the glare handle field in the CIC Mapping record, and then sends the VoIP Reattempt Other Circuit message 610 to the VoIP control 210B on VoIP gateway switch 600B. The VoIP control 210B on VoIP gateway switch 600B receives the VoIP Reattempt Other Circuit message 610, finds a VoIP channel using the VoIP Handle/VoIP Channel Call cache, and starts the new call by sending another VoIP Send Initial Address message back to the B-layer 304B, which then allocates another CIC Mapping record.

Although this invention has been described with reference to particular embodiments, the invention is not limited to these described embodiments. Rather, it should be understood that the embodiments described herein are merely exemplary and that a person skilled in the art may make many variations and modifications without departing from the spirit and scope of the invention. All such variations and modifications are intended to be included within the scope of the invention as defined in the appended claims.

What is claimed is:

1. A method for dynamically mapping virtual Signaling System 7 (SS7) Circuit Identification Codes (CICs) for Voice over Internet Protocol (VoIP) telephone calling between an originating VoIP gateway switch and a terminating VoIP gateway switch over an IP-based packet network comprising:
said terminating VoIP gateway switch receiving an incoming VoIP-enhanced SS7 IAM message having an originating point code (OPC), a destination point code (DPC) and an originating CIC number from said originating VoIP gateway switch for a VoIP telephone call; and
allocating a terminating CIC number from a CIC available list.

2. The method of claim 1, wherein said allocating comprises:
comparing said OPC to said DPC;
if said OPC is less than said DPC, allocating a terminating CIC from an odd available list associated with said CIC pool; and
if said OPC is greater than said DPC, allocating a terminating CIC from an even available list associated with said CIC pool.

3. A method for dynamically mapping virtual Signaling System 7 Circuit Identification Codes (CICs) for Voice over Internet Protocol (VoIP) telephone calling between an originating VoIP gateway switch and a terminating VoIP gateway switch over an IP-based packet network comprising:
dynamically allocating a first CIC number to set up a VoIP call in said originating VoIP gateway switch;
sending a VoIP-enhanced SS7 IAM message containing said first CIC number to initiate a VoIP telephone call;
dynamically allocating a second CIC number to set up said VoIP telephone call in said terminating VoIP gateway switch;
returning an SS7 Information message including said second CIC number;
performing a reverse mapping based on said SS7 Information message; and
sending an SS7 completion of test message to indicate said VoIP telephone call is set up.

4. The method of claim 3, further comprising:
providing an originating VoIP gateway switch for dynamically allocating said first CIC number and sending said VoIP-enhanced SS7 IAM message; and
providing a terminating VoIP gateway switch for receiving said VoIP-enhanced SS7 IAM message and dynamically allocating second CIC number to setup said VoIP telephone call.

5. The method of claim 3, wherein said dynamically allocating said CIC number comprises:
comparing an originating point code (OPC) to a destination point code (DPC);
if said OPC is less than said DPC, allocating a terminating CIC from an odd available list; and
if said OPC is greater than sand DPC, allocating a terminating CIC from an even available list.

6. A method for resolving glare during initiation of a VoIP telephone call between two VoIP gateway switches, each of said two VoIP gateway switches having an originating point code (OPC) and a destination point code (DPC) and having received a VoIP-enhanced SS7 IAM message to initiate said VoIP telephone call, said glare resulting from each received VoIP-enhanced SS7 IAM message including an identical circuit identification code (CIC) number, said method comprising:
each of said two VoIP gateway switches comparing its OPC with its DPC;
if said OPC is less than said DPC and said CIC number is even;
then, discarding said received VoIP-enhanced SS7 IAM message;
otherwise, if said CIC number is odd, processing said received VoIP-enhanced SS7 IAM message;
if said OPC is greater than said DPC and said CIC number is even;
then, processing said received VoIP-enhanced SS7IAM message;
otherwise, if said CIC number is odd, discarding said received VoIP-enhanced SS7 IAM message.

7. A method for resolving glare during initiation of a VoIP telephone call between two VoIP gateway switches, each of said two VoIP gateway switches having an originating point code (OPC) and a destination point code (DPC) and having received a VoIP-enhanced SS7 IAM message to initiate said VoIP telephone call, said glare resulting from each received VoIP-enhanced SS7 IAM message including an identical circuit identification code (CIC) number, said method comprising:
each of said two VoIP gateway switches comparing its OPC with its DPC;
if said OPC is greater than said DPC and said CIC number is even;
then, discarding said received VoIP-enhanced SS7 IAM message;
otherwise, if said CIC number is odd, processing said received VoIP-enhanced SS7 IAM message;
if said OPC is less than said DPC and said CIC number is even;
then, processing said received VoIP-enhanced SS7 IAM message;
otherwise, if said CIC number is odd, discarding said received VoIP-enhanced SS7 IAM message.

8. A method for resolving glare during initiation of a VoIP telephone call between two VoIP gateway switches, each of said two VoIP gateway switches having an originating point code (OPC) and a destination point code (DPC) and having received a VoIP-enhanced SS7 IAM message to initiate said VoIP telephone call, said glare resulting from each received VoIP-enhanced SS7 IAM message including an identical circuit identification code (CIC) number, said method comprising:
each of said two VoIP gateway switches comparing its OPC with its DPC;
if its said OPC is less than said DPC and said CIC number is odd;
then, discarding said received VoIP-enhanced SS7 IAM message;
otherwise, if said CIC number is even, processing said received VoIP-enhanced SS7 IAM message;
if said OPC is greater than said DPC and said CIC number is odd;
then, processing said received VoIP-enhanced SS7 IAM message;
otherwise, if said CIC number is even, discarding said received VoIP-enhanced SS7 IAM message.

9. A method for setting up a voice over Internet protocol (VoIP) telephone call between an originating VoIP gateway switch and a terminating VoIP gateway switch over an IP-based packet network, said method comprising:
said originating VoIP gateway switch sending a VoIP-enhanced SS7 initiating address message (IAM) message to said terminating VoIP gateway switch;
said terminating VoIP gateway switch dynamically allocating a virtual circuit identification code (CIC) number for use by said terminating VoIP gateway switch;
said terminating VoIP gateway switch sending a SS7 Information message including said dynamically allocated virtual CIC number to said originating VoIP gateway switch;
said originating VoIP gateway switch performing a reverse mapping based on said dynamically allocated virtual CIC number; and
said originating VoIP gateway switch sending a SS7 Completion of Test message to said terminating VoIP gateway switch indicating said VoIP telephone call is setup.

10. A method for enabling voice over Internet protocol (VoIP) telephone calling between an originating VoIP gateway switch and a terminating VoIP gateway switch over an IP-based packet network, said method comprising:
said originating VoIP gateway switch sending a VoIP-enhanced SS7 initiating address message (IAM) message to said terminating VoIP gateway switch;
said terminating VoIP gateway switch dynamically allocating a virtual circuit identification code (CIC) number for use by said terminating VoIP gateway switch;
said terminating VoIP gateway switch sending a SS7 Information message including said dynamically allocated virtual CIC number to said originating VoIP gateway switch;
said originating VoIP gateway switch performing a reverse mapping based on said dynamically allocated virtual CIC number;
said originating VoIP gateway switch sending a SS7 Completion of Test message to said terminating VoIP gateway switch indicating said VoIP telephone call is setup;
exchanging said voice packets until a terminating event occurs; and
tearing down said VoIP telephone call.

11. A Voice over Internet Protocol (VoIP) gateway switch for switching VoIP telephone calls over an IP-based packet network comprising:
a pulse code modulated (PCM)/time division multiplexed (TDM) backplane;
a plurality of T1/E1 circuit cards, each in communication with each other over said PCM/TDM backplane, each configured for switching said VoIP telephone calls and configured for dynamically allocating a virtual circuit identification code (CIC) upon receiving a VoIP-enhanced signaling system 7 (SS7) initial address message (IAM) to setup said VoIP telephone calls;
a system bus; and
a system central processor unit (CPU) board configured to communicate with and control said plurality of T1/E1 circuit cards over said system bus.

12. The VoIP gateway switch of claim 11, wherein each of said plurality of T1/E1 circuit cards further comprises:
a B-layer in communication with said system CPU board for mapping between an ISUP circuit number and a VoIP handle used by said system CPU board;
an ISUP layer in communication with said B-layer for setting up and tearing down said VoIP telephone calls in accordance with signaling system 7 (SS7) protocol including using said ISUP circuit number; and
an L-layer in communication with said B-layer for said dynamically allocating a virtual CIC number in VoIP-enhanced SS7 messages as required by said VoIP gateway switch.

13. The VoIP gateway switch of claim 12, wherein each of said plurality of T1/E1 circuit cards further comprises:
an M3UA layer in communication with said L-layer for translating point codes into IP addresses for SS7 message transport across said IP-based packet network;
an SCTP layer in communication with said M3UA layer for transmitting SS7 messages over said IP-based packet network; and
a UDP/IP interface in communication with said SCTP layer for transmitting packets between said SCTP and said IP-based packet network.

14. The VoIP gateway switch of claim 12, wherein each of said plurality of T1/E1 circuit cards further comprises:
an MTP3 layer in communication with said L-layer for selecting a route to a particular point code;
an MTP2 layer in communication with said MTP3 layer for transmitting and guaranteeing receipt of a SS7 message between two adjacent systems in a SS7 data network; and
a serial port interface between and in communication with said MTP2 layer and said SS7 data network for bidirectionally transmitting messages therebetween.

15. A Voice over Internet Protocol (VoIP) system, comprising: a plurality of VoIP gateway switches each configured for communication over a public switched telephone network and over an IP-based network, wherein each of said plurality of VoIP gateway switches comprises:
a pulse code modulated (PCM)/time division multiplexed (TDM) backplane;
a plurality of T1/E1 circuit cards, each in communication with each other over said PCM/TDM backplane, each configured for switching said VoIP telephone calls and configured for dynamically allocating a virtual circuit identification code (CIC) upon receiving a VoIP-enhanced signaling system 7 (SS7) initial address message (IAM) to setup said VoIP telephone calls;
a system bus; and
a system central processor unit (CPU) board configured to communicate with and control said plurality of T1/E1 circuit cards over said system bus.
